(19) United States
(12) Patent Application Publication
(10) Pub. No.: US 2026/0281091 A1
(43) Pub. Date: Sep. 17, 2026

(54) REMOTE CONSOLE FOR BARE METAL MACHINES IN A CLOUD COMPUTING PLATFORM

(71) Applicant: Akamai Technologies, Inc., Cambridge, MA (US)

(72) Inventors: Abraham Massry, Cherry Hill, NJ (US); William Smith, Turnersville, NJ (US); Jesse Alter, Collingswood, NJ (US); April Carter, Charlotte, NC (US)

(21) Appl. No.: 19/081,617

(22) Filed: Mar. 17, 2025

(51) Int. Cl. H04L 9/40

(52) U.S. Cl. CPC H04L 63/08; H04L 63/18

(57) ABSTRACT

A cloud computing platform provides a service that enables the user to access and control their bare metal machine via an out-of-band channel. The user invokes this service by connecting to a session server in a data center in the computing platform. The session server connects to the correct bare metal machine for the authenticated user. It provides the user with a persistent, virtualized session to the serial port of the user's bare metal machine. The solution may be implemented with use of a terminal server that multiplexes a local area network connection from the session server to the serial ports of each bare metal machine. Via this link, the device provides the user with the aforementioned access and control services, enabling the user to configure their bare metal machine even if it is inaccessible through network ports.

### BACKGROUND

### Technical Field

This patent document generally relates to cloud computing services.

### Brief Description of the Related Art

Cloud computing is an information technology delivery model by which shared resources, software and information are provided on-demand over a network (e.g., the publicly-routed Internet) to computers and other devices of customers. This type of delivery model has significant advantages in that it reduces information technology costs and complexities, while at the same time improving workload optimization and service delivery. In a typical use case, an application is hosted from network-based resources and is accessible through a conventional browser or mobile application. Cloud compute resources typically are deployed and supported in data centers that run one or more network applications.

Cloud compute resources may use a virtualized architecture wherein applications run inside virtual servers, or virtual machines (VMs), which are mapped onto physical servers in the data center. The virtual machines typically run on top of a hypervisor, which allocates physical resources to the virtual machines.

The cloud computing provider may also offer “bare metal” servers. In this case, the customer rents the hardware itself and has full, dedicated access to resources on the machine. A hypervisor and other virtualization software are not necessarily included in this offering, although the provider could facilitate the user installing such applications for their own purposes.

As part of provisioning of a new machine (virtualized or bare metal) the platform can assign it one or more public IP addresses. With this public IP address, an administrative user can access and control the virtual machine, typically through a program referred to as a shell. The shell enables the user to interact with their virtual machine's operating system, including its file and process management and configuration capabilities.

It can be useful, and even necessary, to provide an alternative methodology for the user to access and control their machine. For example, a user might misconfigure their machine such that it is not reachable at its public assigned IP address. To this end, it is known in the prior art for a cloud computing platform to provide an “out-of-band” access and control mechanism allowing users to contact the virtual machine through the platform's services and through a back-end administrative IP address. This may be thought of as a remote console provided through out-of-band text and/or graphical interfaces.

In the prior art, there are several known methodologies for providing out-of-band access and control services to virtual machines. The simplest way is to have a user's client device connect directly to the host that contains their virtual machine. Through a central management interface, the user obtains the hostname of the host running their VM, and configures a set of credentials (e.g., username/password) for a restricted user account on the host. The user can make a secure shell (SSH) connection to the host using those credentials. SSH is a standard internet protocol. The host operating system then connects to an emulator and virtualizer for the virtual machine, such as QEMU. In one implementation, a GNU screen process is used to wrap the emulation process and expose a serial port, hence providing the user with a serial terminal emulator through which they may interface with their virtual machine via text based commands.

To improve the foregoing approach, a special SSH-compliant server can be deployed into each data center. This is referred to as a shell session server. This shell session server runs in its own virtual machine. That virtual machine is sometimes referred to as an infrastructure VM, because it is not a guest VM for a customer but rather part of the compute platform's operational resources. The user then connects to this shell session server, knowing that they have virtual machines somewhere in that data center. The shell session server interacts with back-end APIs to authenticate the user's credentials and to learn the hostname and administrative IP address of the host that has the user's virtual machine, as well as the identifiers for the virtual machine itself. The shell session server may present an interface to the user through which the customer can query and view the virtual machines they have in that data center, and choose to connect to one. The shell session server then makes the connection to the virtual machine on the host using the administrative IP address and proxies the communications between client and virtual machine.

An improvement to the foregoing approach was to have the user log in to a cloud manager (a web based UI), which (upon successful authentication) gives them a URL with a hostname resolving to the IP address of the shell session server in the correct data center, and an encrypted, time-limited token to use for connecting to that shell session server. The token encrypts the user identification and the VM it is valid for. The user presents this token to the shell session server, which validates it, locates the VM on a given host, and connects the user to the VM.

A web-based alternative involves a user agent (e.g., browser or an AJAX application) connecting to a web-based control center to authenticate and receive an encrypted token. As before, the user logs in to a cloud manager (a web based UI), which (upon successful authentication) gives them a URL with the IP address of the shell session server in the correct data center. The user connects to the shell session server in the data center, and upgrades from HTTP to websockets. The shell session server extracts credentials from the token and validates the token with the back-end APIs. As before, it then uses the back end API to learn the hostname and administrative IP address of the host that has the customer's virtual machine. The shell session server then can export the SSH data from the host to this websockets session.

A graphical interface can be provided by using a VNC client or web-based noVNC client leveraging Javascript code downloaded into the user's browser from the control center. In this option, the shell session server in the data center creates a VNC session with the virtual machine's VGA port on the host, which can be exposed by QEMU through a websocket. In this way, the user's device can send mouse and keyboard data, while receiving graphics data from the virtual machine in a VNC data stream over websockets.

A final alternative is to provide a web-page interface. In this approach, the user again connects to a web-based control center through an HTTP/websockets session. As explained before, the shell session server establishes a session to the virtual machine's screen/QEMU session on the host. That provides a text-based terminal, as mentioned before. But in this case, the user's browser is served with a Javascript application that converts the text commands and codes from the websockets stream into HTML and CSS, so the user is viewing a web page console for their virtual machine.

In practice, the aforementioned shell session server in the data center can support all of the foregoing methodologies to provide a rich set of terminal options. All of the foregoing methodologies therefore constitute prior art known by others.

Further improvements on the foregoing methodologies are discussed in U.S. application Ser. No. 18/962,268, titled “REMOTE CONSOLE FOR VIRTUAL MACHINES IN A CLOUD COMPUTING PLATFORM”, filed on Nov. 27 2024 and published as U.S. Patent Publication No.______, the teachings of which are hereby incorporated by reference.

Another approach to out of band access is to use an IPMI port (Intelligent Platform Management Interface). The IPMI port, often implemented with Ethernet/RJ-45 cabling, provides direct access to the machine's Baseboard Management Controller (BMC). The BMC is typically an independent system on a chip that provides control and monitoring features for the system it is attached to. But support for this feature relies on hardware and firmware support from vendors. If a security vulnerability arises, a fix in the hardware and/or firmware may be required. All of the foregoing solutions are concerned with providing out of band access to virtual machines, or in the case of IPMI, present other concerns.

Consequently, out of band access to bare metal machines present a challenge. The problem is that it is typically unacceptable with bare metal offerings to run management software for the cloud computing platform, such as the virtualization and other on-machine software that enabled the above solutions. Hence, another approach is needed to provide out of band access and control services for bare metal offerings, or other offerings in which it is not suitable to install such administrative software. The teachings of this patent document address this need and other needs that will become apparent to those skilled in the art upon review of the subject matter disclosed herein.

The teachings presented herein improve the functioning of a computer system itself, providing new and improved methodologies for out-of-band access and control of bare metal resources and for managing access to such resources in a multi-tenant platform. Those skilled in the art will understand these and other improvements from the teachings hereof.

### BRIEF SUMMARY

This section describes some pertinent aspects of this invention. Those aspects are illustrative, not exhaustive, and they are not a definition of the invention.

A multi-tenant cloud computing platform provides servers and other compute resources on-demand for users. Some resources are “bare metal” servers, wherein the customer rents the hardware of a machine without any other tenants.

The cloud computing platform provides a service that enables the user to access and control their machine via an out-of-band channel. This access can be used for administrative purposes or recovery purposes, such as when the machine is inaccessible through its network ports.

A user invokes this service by authenticating through a user interface, and then connecting to a session server in a data center in the computing platform. The session server provides the authenticated user with a persistent, virtualized console session to the serial port of their bare metal machine. The solution may be implemented with use of equipment, such as a terminal server that multiplexes a local area network connection from the session server to the serial ports of each bare metal machine. The serial ports, it should be understood, are the physical serial ports of the bare metal machine not merely an emulation thereof. Via this link, the platform device provides the user with the aforementioned access and control services. These services are provided out of band from the typical network communication channel, i.e., via the network ports, to the machine.

The claims are incorporated by reference into this section, in their entirety.

### BRIEF DESCRIPTION OF THE DRAWINGS

The invention will be more fully understood from the following detailed description taken in conjunction with the accompanying drawings, in which:

FIG. 1 is a diagram illustrating an implementation of a server machine in a cloud computing platform, in accordance with one embodiment of the teachings hereof;

FIG. 2 is a diagram of a data center in a cloud computing platform, in accordance with one embodiment of the teachings hereof;

FIG. 3 is a diagram of a control plane for a cloud computing platform, in accordance with one embodiment of the teachings hereof;

FIG. 4 is a diagram illustrating a methodology for a user to access and control their bare metal machine, in accordance with one embodiment of the teachings hereof;

FIG. 5 is a diagram illustrating the role and function of the session server in the platform infrastructure; and,

FIG. 6 is a block diagram illustrating hardware in a computer system that may be used to implement the teachings hereof.

Numerical labels are provided in some FIGURES solely to assist in identifying elements being described in the text; no significance should be attributed to the numbering unless explicitly stated otherwise.

### DETAILED DESCRIPTION

The following description sets forth embodiments of the invention to provide an overall understanding of the principles of the structure, function, manufacture, and use of the methods and apparatus disclosed herein. The systems, methods and apparatus described in this application and illustrated in the accompanying drawings are non-limiting examples; the claims alone define the scope of protection that is sought. The features described or illustrated in connection with one exemplary embodiment may be combined with the features of other embodiments. Such modifications and variations are intended to be included within the scope of the present invention. All patents, patent application publications, other publications, and references cited anywhere in this document are expressly incorporated herein by reference in their entirety, and for all purposes. The term “e.g.” used throughout is used as an abbreviation for the non-limiting phrase “for example.”

The teachings hereof may be realized in a variety of systems, methods, apparatus, and non-transitory computer-readable media. It should also be noted that the allocation of functions to particular machines is not limiting, as the functions recited herein may be combined or split amongst different hosts in a variety of ways.

Any reference to advantages or benefits refer to potential advantages and benefits that may be obtained through practice of the teachings hereof. It is not necessary to obtain such advantages and benefits in order to practice the teachings hereof.

### Cloud Computing

As mentioned, cloud computing is a model of service delivery for enabling on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. Available services models that may be leveraged in whole or in part include: Software as a Service (SaaS) (the provider's applications running on cloud infrastructure); Platform as a service (PaaS) (the customer deploys applications that may be created using provider tools onto the cloud infrastructure); Infrastructure as a Service (IaaS) (customer provisions its own processing, storage, networks and other computing resources and can deploy and run operating systems and applications). Typically, the cloud computing environment has a set of high level functional components that include a front end identity manager, a business support services (BSS) function component, an operational support services (OSS) function component, and the compute cloud components themselves.

A representative cloud computing infrastructure is implemented in a data center operated by a computing platform provider. A representative provider is Linode®, now owned by Akamai Technologies, Inc., of Cambridge, Massachusetts. In the context of this patent document, the service offering is a bare metal machine or other dedicated resource unsuitable for installing administrative software to enable out of band access and control.

Of course, within dedicated machines, a cloud computing customer may install and run hypervisors and/or virtualized environments.

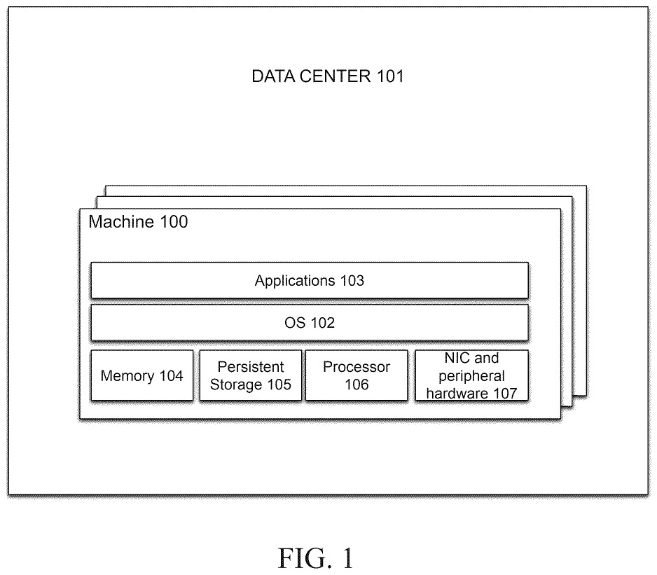

A representative machine 100 in a datacenter 101 is depicted in FIG. 1. The machine 100 has associated therewith persistent storage 105, the amount of which typically varies based on size and type, and memory (RAM) 104. The local persistent storage typically is built on enterprise-grade SSDs (solid state disks). The machine's persistent storage space can be allocated to individual disks. Disks can be used to store any data, including the operating system, applications, and files. A representative machine is equipped with two (2) disks, a large primary disk used to store the operating system, software, and data, and a smaller swap disk, which is used in the event the VM runs out of memory. While two disks are typical, the machine can be configured to have many more disks, which can serve a variety of purposes including dedicated file storage or switching between entirely different operating system distributions. When multiple disks are added to a machine, configuration profiles are used to determine the disks that are accessible when the machine is powered on, as well as which of those disks serves as a primary root disk. Using tools provided by the service provider, disks can be created, resized, cloned and deleted. The machines also provides a set of central processing units (CPUs) shown as processor 106, and a variety of other hardware including a network interface cards and physical ports for networking 107, e.g., Gigabit Ethernet card and port(s), Intelligent Platform Management Interface IPMI (dedicated or combined with the Ethernet port), USB and other serial ports.

As shown in the FIG. 1, a bare metal machine 100 is in a data center 101. The machine 100 the customer may run applications of its choosing on the bare metal machine 100, such as an OS (aforementioned Linux) 102, user space applications 103, and the like. Some of the software (such as an open source Linux distribution or networking software) may be provided or pre-installed at the direction of the customer by the cloud computing platform. The customer may even run a hypervisor to create its own dedicated but virtualized environment.

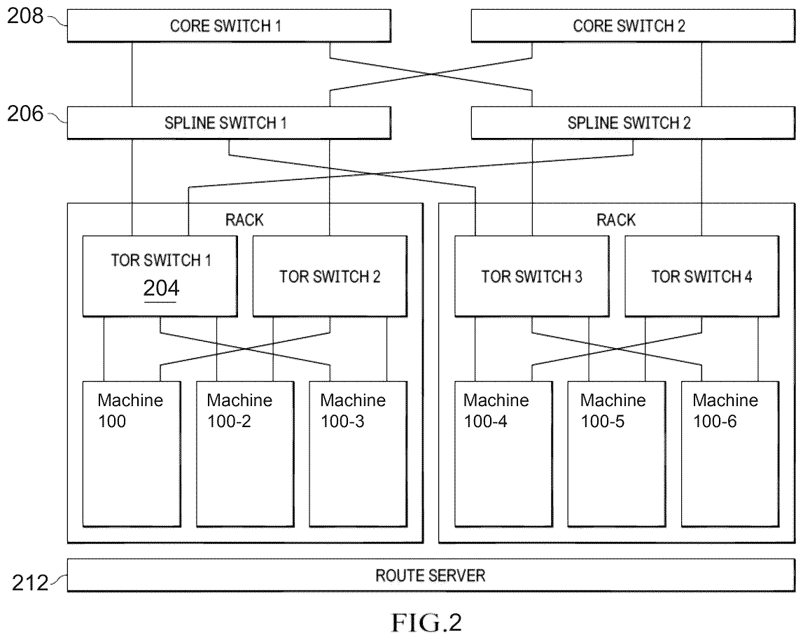

FIG. 2 depicts a representative core site (a data center) that supports a known cloud compute infrastructure. As depicted, this architecture is based on a non-blocking, multistage switching network (e.g., CLOS) with Border Gateway Protocol (BGP) as the routing protocol between switches. As depicted, the machines 100 are the bare metal machines shown in FIG. 1. As illustrated, each machine 100 is connected with two TOR (Top-Of-Rack) switches 204 with one physical ethernet cable to each of them. A Top-of-Rack router or switch is a network that provides connectivity between machines 100 in a rack and between those machines 100 and the rest of a network fabric, transit, or other such connectivity. Upstream (north) of the ToR is a set of leaf or bolt routers, in this example spine 206 and core 208 switches, which connect to the core switches 110. Routing between hosts and switches is done through BGP; all switches and hosts speak BGP with switches and hosts they have a physical connection with. In addition, typically the machines 100 have an eBGP connection with one or more instances of a route server 212, which acts as a distributed network controller. The route server 212 may execute a route server manager process that performs leader election and starts/stops route server instances as needed. The machines 100 use an Internet routing protocol suite (e.g., FRR or FRRouting) to establish eBGP connections to the TORs and route servers and install routes in the Linux kernel.

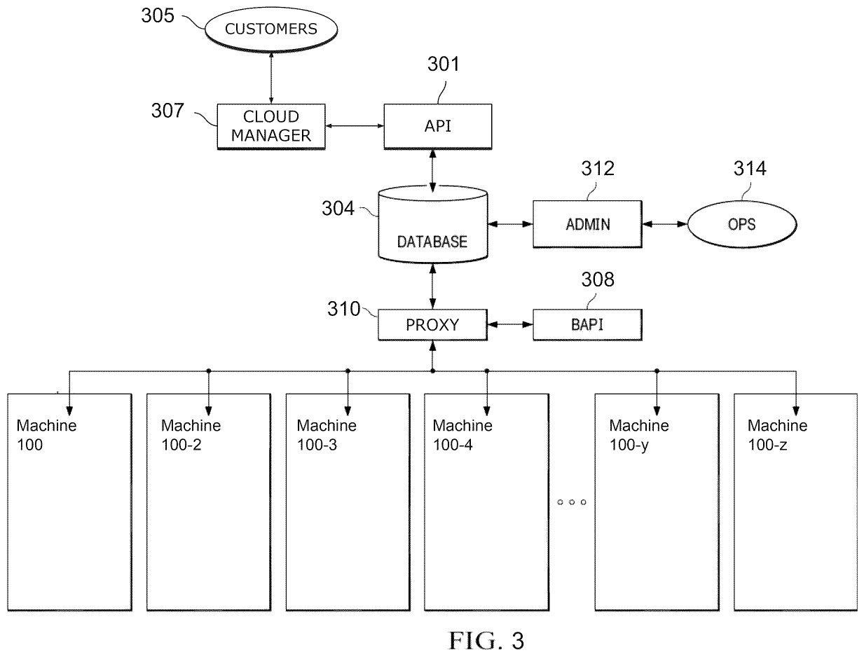

The above-described core site is managed by a control plane that is now described and depicted with reference to FIG. 3. The machines 100 through 100-6 interoperate with a network-accessible database 304, which may be located remotely.

A given machine 100 may be configured to host guest virtual machines for users or to provide bare metal offerings for users. For details about the virtualized machine (VM) use case, the reader is directed to the aforementioned U.S. application Ser. No. 18/962,268, now published as ______. The description that follows relates to the use case for bare metal machines.

Users are assigned to bare metal machines by the allocator. The allocator is the control plane component responsible for assigning users onto available hardware. The job of the allocator, which may be implemented in the form of a Python function, is to balance load across hardware in a customer-selected compute region, and to ensure that IP addresses, disk space, CPU, memory and other constrained machine resources, all have availability to accept the new workload. The database 304, which may be implemented as any number of known SQL instances, is a singleton that acts both as a data source and as a message bus. In particular, the database 304 acts as a message bus among end users interacting with the cloud compute service (typically accessed at a secure network-accessible domain), the allocator making placement decisions, and one or more other compute infrastructure hosts performing jobs in service of end user requests. For example, when a customer 305 (via user agent) wants a machine 100 on the compute service, a series of jobs are inserted into the database 304 with a Identifier (ID) selected by the allocator. As a result, the corresponding machine 100 receives the user assignment and is configured with the user's preferences (including network and software options). Error handling and observability are all sent back to the database 304 and reflected in a user interface (UI) dashboard (cloud manager 307). Cloud manager 307 is in communication with the database 304 via an API 301. The API 301 may also be exposed such that customers 305 can integrate with the platform without using the cloud manager UI 307, in alternative embodiments.

Within this service, the datacenter acts as a compute boundary. In an example implementation, a service datacenter then is a formal entity in the database 304 and is the boundary into which customers select and deploy compute resources. As also shown, the site may include a Back-end Application Programming Interface (BAPI) 308 that is used by various components in the platform. A caching proxy layer 310 may be implemented in between the database and hosts for scalability and resilience. The system can also include data collector components (e.g., which may run on behalf of the database 304) that collect individual machine statistics that are used as the data source of the Analytics tab in a Cloud Manager 307 web based UI.

In a representative embodiment, the control plane described above is managed “as-a-service” from a secure web application available, e.g., from a service provider domain or subdomain. After becoming a customer, secure permissioned access to the control plane is provided to enable the customer to provision and manage its workloads in the compute infrastructure.

### Out of Band Access to Bare Metal Machines

With the foregoing context, now described are systems and methods for providing compute customers with alternative access and control of their bare metal machines 100.

Once a machine 100 is assigned to a customer, the platform assigns it a public IP address, which the customer's administrative users can use to access it. This IP address is used to contact the machine 100 via its network interface. This means that the physical network port(s) on the machine—typically Ethernet with RJ-45 jacks—carry the network data.

If the machine 100 is unreachable through the network ports (such as through misconfiguration or software fault), an alternative access and control channel is used.

There are several known ways in the prior art for a cloud computing platform to provide such an out-of-band access and control mechanism, as described in the Background section. The teachings hereof present new and improved techniques for doing so that are particularly suited for access to bare metal machines 100.

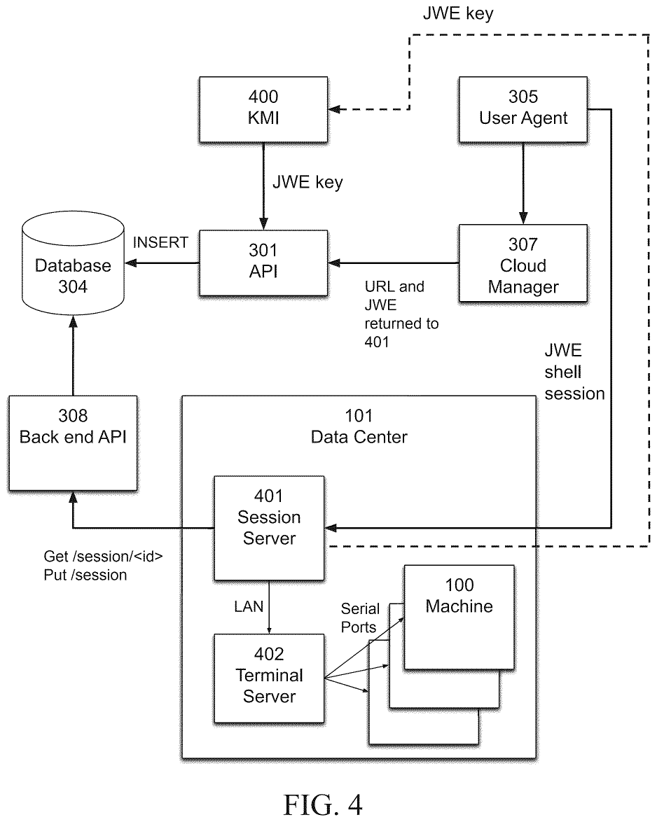

FIG. 4 illustrates a representative implementation. The components shown in FIG. 4 correspond to like-numbered components shown and described in connection with FIG. 3.

Note that the arrows in FIG. 4 represent connections between components and the direction of the arrows indicate which component initiates the connection (more specifically, which plays the role of client and which plays the role of a server) so as to help illustrate a workflow. Data flow on the connections may be bi-directional.

A representative workflow proceeds as follows. A user connects to a web based cloud manager 307 with their user agent (e.g., browser) 305 running on their client device. The user authenticates to the cloud manager using conventional techniques (e.g., presenting credentials and multi-factor authentication techniques). Using the Cloud Manager 307 UI the user requests an administrative shell (shell session request) to their bare metal machine. In this example, the bare metal machine that the user wants to reach is depicted as machine 100 in data center 101.

Responding to this shell session request, Cloud Manager 307 makes a request to API 301, which is coupled to the database 304. The API 301 generates a JSON Web Encryption (JWE) token encrypted with a JWE key from KMI 400 that is associated with the compute platform, or alternatively a JWE key specifically associated with this user and/or the user organization. The API 301 inserts the shell session ID into the database 304.

KMI 400 refers to a key management infrastructure, sometimes referred to as a key vault. A key management infrastructure may be implemented in known ways such as described in U.S. Pat. No. 7,096,266 B2 and U.S. Pat. No. 11,418,352 B2, the contents of which are hereby incorporated by reference in their entirety, as modified by the teachings below and otherwise in this document.

The API 301 can encrypt several pieces of information into the JWE. One is the identifier for the machine 100 that the user wants to access (e.g., the platform's identifier for the bare metal machine asset). Another is the shell session ID. The shell session ID is an authenticator used to establish (or resume) a session and hence can be implemented as a sensitive bearer token. Shell sessions run within a screen instance per bare metal machine 100 on the session server 401. The session server 401 is a network device operated by the platform. There may be more than one in a data center 101.

Preferably, the API 301 inserts the token into a URL as, e.g., a URL parameter or pathname. The hostname for that URL points to the session server 401 directly, or to an overlay network, e.g., a content delivery network (CDN) which will proxy to the session server 401. The API 301 returns this URL with the JWE to the cloud manager 307.

The cloud manager 301 directs the user agent 305 to the URL returned from the API 301. There are at least two ways that the workflow can proceed from here.
(A) Direct embodiment. As mentioned, the hostname in the URL can point to the session server 401, which means that the hostname is resolved to an IP address of the session server 401. The user agent 305 connects to the shell session server 401 and presents the token. The shell session server 401 obtains a key for the JWE from KMI 400, and uses it to decrypt the embedded token and recover the information therein—namely, the shell session ID and identifier for the user's bare metal machine.
(B) Overlay Network/Proxy embodiment. In the alternative embodiment where the URL points to the CDN, the hostname must be resolved to an IP address of one of the CDN servers through the DNS system, as known in the art. The resolution process thus leverages the mapping and request routing infrastructure of the CDN to direct the user agent 305 to a selected CDN server. The user agent 305 is given the IP address of a specific CDN server machine that is nearby (in network distance terms) and not overloaded CDN server. (Note that in an alternative embodiment, the IP address may be an Anycast IP address.) The user agent 305 connects to the CDN server and sends an HTTP Get request for the URL. In response, the CDN server looks up its content handling rules (configuration) for this hostname property. CDN servers have been configured with special configuration instructions for this hostname, as it is essentially associated with a control plane of the cloud computing platform. The instructions tell the CDN server to obtain the appropriate JWE key from the CDN's key management infrastructure (e.g., 400 KMI). The CDN server uses the key to decrypt the embedded token and recover the information therein. The CDN server goes forward to the session server 401, which resides in one of cloud compute platform data centers 101. The CDN server connects to the shell session server 401, and sends it the shell session ID and identifier for the user's bare metal machine. More detail about the overlay network/proxy embodiment can be found in U.S. application Ser. No. 18/962,268, titled “REMOTE CONSOLE FOR VIRTUAL MACHINES IN A CLOUD COMPUTING PLATFORM”, filed on Nov. 27, 2024 and published as U.S. Patent Publication No.______, the teachings of which are hereby incorporated by reference.

Next, the shell session server 401 validates the session ID with the back-end API 308. The session server 401 establishes a virtualized shell session for the user agent 305. This session is coupled to a persistent forward SSH connection to a terminal server 402 over the LAN in the data center 101. The terminal server 402 has a physical network port for the LAN and also physical serial connections to the serial ports of each bare metal machine 100. The terminal server 402 multiplexes the network to the serial ports. Terminal servers 402 (sometimes referred to as serial console servers) are a product known in the art; a suitable product is the Serial Console Server available from OpenGear, Inc. of Sandy, Utah, USA.

The session enables the user to interact with the serial port of the machine 100 as a serial terminal, providing a text based console through which the user can issue commands, receive responses and which keeps state. The session server 401 handles multiple sessions at a time to many different bare metal machines.

To handle two way communication on this channel, the communications can be implemented with HTTP messaging upgraded to Websockets. Websockets is a well known HTTP protocol upgrade that allows a client and server to exchange messages back and forth (in contrast to the single request-then-response style of HTTP). Websockets also provides a “protocols” field, which allows more specific “(sub-)protocols” to be negotiated between the client and server using HTTP headers. Those sub-protocols can be used to implement custom messaging protocols for the text or graphical interfaces to the VM in the shell session. Preferably, all connections between platform components, including between host 703 and CDN server 708, and between CDN server 708 and User Agent 305 are mutually authenticated, e.g., with certificate based authentication.

With the foregoing description in mind, some additional implementation details are now provided.

### Session Server 401

In a preferred embodiment, the session server 401 runs a Linux based operating system and for each bare metal machine, this operating system runs a persistent console session. The console session may be implemented with, e.g., a GNU screen process used to expose a serial port, hence providing the user with a serial terminal emulator through which they may interface with their virtual machine via text based commands). Each console session is associated with a user on the terminal server or other intermediary hardware. With this console session, the session server 401 provides a variety of functions beneficial for a multi-tenant environment. For example:
Each platform user can be provided with logging (e.g., the last 3 sessions) from what was output on the console to their bare metal machine to the serial port. This information is available through the user interface of the session server 401. This ability is helpful for a user to be able to scroll back and understand past events, such as access or kernel panics. Scrollback can be limited to a session, so that one user going through the session server to a bare metal machine does not see the logs of a prior user who had been renting the bare metal machine beforehand.
Activity can be logged at a granular level (such as maintaining a transcript, capturing keystrokes, monitoring for malicious activity), and can be easily updated.
The session server can provide a custom shell to intercept, modify and/or sanitize the output from the terminal server or other underlying hardware. For example escape sequences can be sanitized so that the user is not allowed to perform unintended actions on the underlying hardware including the terminal server, bare metal machine, or otherwise. This serves to conceal the control plane (commands and escape sequences) of those network elements from the user.
A management interface accessible to the user by exiting the console session and perform management actions with respect to the bare metal machine, such as boot, shutdown, view jobs, and the like.

In addition, the session server 401 provides other functions relevant to the platform operations, including:
Storing configurations for all active bare metal machines 100 on disk to enable reestablishing SSH connections for them in the event of a power failure, or if they go away for some other reason.
Run a daemon to check the health of all active sessions, and restart them if necessary.
Terminate connections for bare metal machines 100 during deprovisioning.
Runs a small application to accept requests from the back end API 408 to orchestrate actions like establishing a new session, rotating the screenlog (so that subsequent users do not see logs from earlier users), and removing a bare metal machine.

### Provisioning & Deprovisioning of a Bare Metal Machine 100

When a bare metal machine 100 is provisioned, the following steps can be taken:
1. Back end API 408 sends a request to the session server 401 notifying it of the new machine, along with the console hostname, port, and username, and the platform identifier that it has been assigned.
2. The session server 401 creates a new configuration file for that machine 100 and stores it in a corresponding new directory.
3. The session server 401 creates a new user for that machine 100, sets its home directory to the aforementioned directory. It also sets the shell to the session server 401 screen session shell, and generates SSH keys.
4. The session server 401 copies the SSH keys for downstream connections (e.g. for the terminal server 402) into the home directory.
5. The session server launches a screen session as the user in the home directory, named as the platform identifier, and using its own keys for the given console with the user, and connecting to the serial port of the machine 100.

When a user wants to connect to a console, the following steps can be taken:
1. The user connects to the session server 401 as described with respect to FIG. 4.
2. The session server 401 shell for that user automatically attaches to that bare metal machine 100's screen session.

When a bare metal machine 100 is shut down, the back end API 408 informs the session server 401 that it should rotate screen logs for that machine 100. The session server 401 then does so by deleting or moving the screenlog to a backup store.

When a bare metal machine 100 is shut down, the following steps can be taken:
1. The back end API 408 informs the session server 401 that it should remove the bare metal machine 100 user.
2. The user is removed, and any active SSH connections as that user are terminated.
3. The screen session is terminated.
4. The home folder is moved to a disabled location or deleted.

### Security Features of the Session Server 401

The position of the session server 401 is advantageous for providing a security layer in front of the serial ports of the machines 100. With prior art solutions, such as use of the IPMI port, there is direct access to the hardware of the machine 100, bypassing the operating system. That design relies on the security and maintenance of the IMPI interface (both its software and hardware), so fixing security vulnerabilities requires upgrades to both. In contrast, the teachings hereof may allow the computing platform to implement software only upgrades that can be pushed out quickly.

In addition, the teachings hereof offer the computing platform an intermediary monitoring and enforcement point, in the form of the session server 401. The session server 401 can be enhanced to provide proprietary security measures, such as a firewall, a limited command set, and enhanced logging and alerting to a network operations center for suspicious activities.

### Role of the Session Server in Cloud Compute Platform

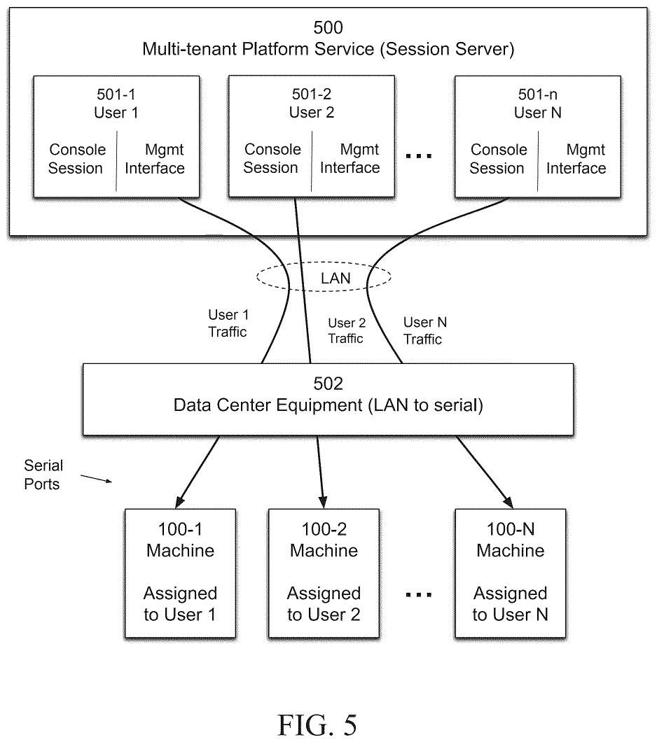

FIG. 5 illustrates the data center components shown in FIG. 4 but in a more generalized fashion. The session server 401 functions as a software-based multi-tenant service layer 500 that sits between the rest of the cloud computing platform and the hardware in the data center (namely, the bare metal machines 100 and other intermediate data center equipment 502 such as the terminal server 401).

For each user of a bare metal machine 100, this platform service 500 can host an associated persistent console session to their bare metal machine 100 with the aforementioned logging, security, custom shell, and other characteristics as previously described. At the same time, it can provide the user a management interface, accessed by existing the console session. The management interface can be used for management and control of the bare metal machine 100 itself, e.g., issuing such base actions as boot, shutdown, view jobs, restart and so on.

The platform service 500 hides the complexity of the hardware of the data center, enabling a user to run a console session as if they are directly connected to their machine's 100 serial port, without the intervening complexity of the data center equipment 502 and regardless of the make, model, and other hardware characteristics of their machine 100.

### JWE Format

As mentioned above, JWE stands for JSON Web Encryption, a well known standard for encrypting and authenticating JSON data. It is used to convey host and session information securely. In this context, “securely” means that a client (e.g., user agent 305) possessing a JWE token is unable to determine the information in the token and that the JWE tokens cannot be “forged” by adversaries.

In a representative implementation, the JWE can be constructed as follows:
JOSE header (unencrypted):
   “enc”: “A128CBC-HS256”—AES-128 in CBC mode with sha256 HMAC
   “kid”: <key_id>—key identifier; changed to accomplish key rotation, e.g., 1
   “exp”: <epoch>—epoch time (UTC) of expiration of the token
The (encrypted) payload is a JSON-encoded object with these keys:
   “connect”: “< . . . >”—The IP or hostname the CDN server 708 should use to connect to the host 703.
   “host”: “< . . . >”—The hostname CDN server 708 should use for origin SNI/Host Header/Cert validation.
   “shell session id”: “<id>”—The session identifier (random UUID-4 with the last N characters removed) to be forwarded to the host 703.

### Cloud Manager and API Interfaces

It should be understood that in alternate embodiments, the API 301 could be configured to be exposed to the customer user agent 305. In such an approach, the user agent 305 might connect and authenticate directly to the API 301 to obtain the JWE and CDN URL.

### Computer Based Implementation

The teachings hereof may be implemented using conventional computer systems, but modified by the teachings hereof, with the components and/or functional characteristics described above realized in special-purpose hardware, general-purpose hardware configured by software stored therein for special purposes, or a combination thereof, as modified by the teachings hereof.

Software may include one or several discrete programs. Any given function may comprise part of any given module, process, execution thread, or other such programming construct. Generalizing, each function described above may be implemented as computer code, namely, as a set of computer instructions, executable in one or more microprocessors to provide a special purpose machine. The code may be executed using an apparatus—such as a microprocessor in a computer, digital data processing device, or other computing apparatus—as modified by the teachings hereof. In one embodiment, such software may be implemented in a programming language that runs in conjunction with a proxy on a standard Intel hardware platform running an operating system such as Linux. The functionality may be built into the proxy code, or it may be executed as an adjunct to that code.

While in some cases above a particular order of operations performed by certain embodiments is set forth, it should be understood that such order is exemplary and that they may be performed in a different order, combined, or the like. Moreover, some of the functions may be combined or shared in given instructions, program sequences, code portions, and the like. References in the specification to a given embodiment indicate that the embodiment described may include a particular feature, structure, or characteristic, but every embodiment may not necessarily include the particular feature, structure, or characteristic.

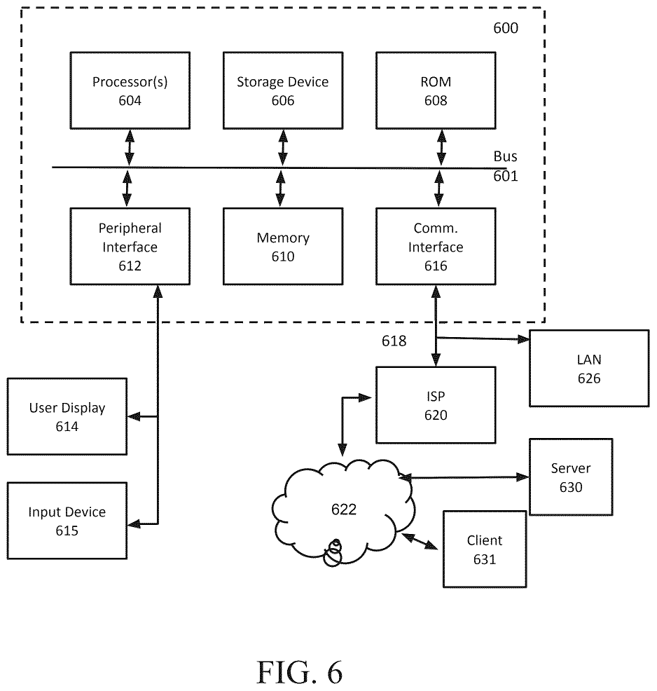

FIG. 6 is a block diagram that illustrates hardware in a computer system 600 upon which such software may run in order to implement embodiments of the invention. The computer system 600 may be embodied in a client device, server, personal computer, workstation, tablet computer, mobile or wireless device such as a smartphone, network device, router, hub, gateway, or other device. Representative machines on which the subject matter herein is provided may be a computer running a Linux or Linux-variant operating system and one or more applications to carry out the described functionality.

Computer system 600 includes a microprocessor 604 coupled to bus 601. In some systems, multiple processor and/or processor cores may be employed. Computer system 600 further includes a main memory 610, such as a random access memory (RAM) or other storage device, coupled to the bus 601 for storing information and instructions to be executed by processor 604. A read only memory (ROM) 608 is coupled to the bus 601 for storing information and instructions for processor 604. A non-volatile storage device 606, such as a magnetic disk, solid state memory (e.g., flash memory), or optical disk, is provided and coupled to bus 601 for storing information and instructions. Other application-specific integrated circuits (ASICs), field programmable gate arrays (FPGAs) or circuitry may be included in the computer system 600 to perform functions described herein.

A peripheral interface 612 may be provided to communicatively couple computer system 600 to a user display 614 that displays the output of software executing on the computer system, and an input device 615 (e.g., a keyboard, mouse, trackpad, touchscreen) that communicates user input and instructions to the computer system 600. However, in many embodiments, a computer system 600 may not have a user interface beyond a network port, e.g., in the case of a server in a rack. The peripheral interface 612 may include interface circuitry, control and/or level-shifting logic for local buses such as RS-485, Universal Serial Bus (USB), IEEE 1394, or other communication links.

Computer system 600 is coupled to a communication interface 616 that provides a link (e.g., at a physical layer, data link layer) between the system bus 601 and an external communication link. The communication interface 616 provides a network link 618. The communication interface 616 may represent an Ethernet or other network interface card (NIC), a wireless interface, modem, an optical interface, or other kind of input/output interface.

Network link 618 provides data communication through one or more networks to other devices. Such devices include other computer systems that are part of a local area network (LAN) 626. Furthermore, the network link 618 provides a link, via an internet service provider (ISP) 620, to the Internet 622. In turn, the Internet 622 may provide a link to other computing systems such as a remote server 630 and/or a remote client 631. Network link 618 and such networks may transmit data using packet-switched, circuit-switched, or other data-transmission approaches.

In operation, the computer system 600 may implement the functionality described herein as a result of the processor executing code. Such code may be read from or stored on a non-transitory computer-readable medium, such as memory 610, ROM 608, or storage device 606. Other forms of non-transitory computer-readable media include disks, tapes, magnetic media, SSD, CD-ROMs, optical media, RAM, PROM, EPROM, and EEPROM, flash memory. Any other non-transitory computer-readable medium may be employed. Executing code may also be read from network link 618 (e.g., following storage in an interface buffer, local memory, or other circuitry).

It should be understood that the foregoing has presented certain embodiments of the invention but they should not be construed as limiting. For example, certain language, syntax, and instructions have been presented above for illustrative purposes, and they should not be construed as limiting. It is contemplated that those skilled in the art will recognize other possible implementations in view of this disclosure and in accordance with its scope and spirit. The appended claims define the subject matter for which protection is sought.

It is noted that any trademarks appearing herein are the property of their respective owners and used for identification and descriptive purposes only, and not to imply endorsement or affiliation in any way.

1. In a multi-tenant cloud computing platform, a method performed to provide users with out of band access to bare metal machines, the method comprising:
communicating with a user agent to authenticate a user;
responsive to successful authentication, connecting the user agent over a wide area network to a shared software-implemented service in a data center in the multi-tenant cloud computing platform, the data center having a plurality of bare metal machines for users; and,
responsive to the connection from the user agent and an identifier for the user, the software-implemented service providing the user with a console session into the user's currently assigned bare metal machine; and,
the software-implemented service connecting to the bare metal machine through intermediary hardware in the data center to a physical serial port of the user's currently assigned bare metal machine.

2. The method of claim 1, the intermediary hardware comprising a multiplexing device.

3. The method of claim 1, the console session providing any of: custom shell, sanitization of intermediary hardware control functions, custom logging, custom scroll back.

4. The method of claim 1, the shared software-implemented service blocking the user from control of the intermediary hardware.

5. The method of claim 1, the intermediary hardware comprising a terminal server.

6. The method of claim 1, the physical serial port being distinct from a network port of the user's currently assigned bare metal machine.

7. The method of claim 1, the shared software-implemented service simultaneously providing a plurality of console sessions for each of a plurality of authenticated users to the physical serial ports of their bare metal machines.

8. The method of claim 1, the intermediary hardware comprising a multiplexing device that operates to multiplex between a local area network port and each of a plurality of respective physical serial ports.

9. A system, comprising:
a server operative to:
communicate with a user agent to authenticate a user;
responsive to successful authentication, connect the user agent over a wide area network to a shared software-implemented service in a data center in a cloud computing platform, the data center having a plurality of bare metal machines for users; and,
the shared software-implemented service operative to:
responsive to the connection from the user agent and an identifier for the user, provide the user with a console session into the user's currently assigned bare metal machine; and
connect to the bare metal machine through intermediary hardware in the data center to a physical serial port of the user's currently assigned bare metal machine.

10. The system of claim 9, the intermediary hardware comprising a multiplexing device.

11. The system of claim 9, the console session operative to provide any of: custom shell, sanitization of intermediary hardware control functions, custom logging, custom scroll back.

12. The system of claim 9, the shared software-implemented service operative to block the user from control of the intermediary hardware.

13. The system of claim 9, the intermediary hardware comprising a terminal server.

14. The system of claim 9, the physical serial port being distinct from a network port of the user's currently assigned bare metal machine.

15. The system of claim 9, the shared software-implemented service operative to simultaneously provide a plurality of console sessions for each of a plurality of authenticated users to the physical serial ports of their bare metal machines.

16. The system of claim 9, the intermediary hardware comprising a multiplexing device that operates to multiplex between a local area network port and each of a plurality of respective physical serial ports.

17. A non-transitory computer readable medium storing code for execution on at least one hardware processor, the code including code causing at least one computer to, when executed perform steps comprising:
communicating with a user agent to authenticate a user;
responsive to successful authentication, connecting the user agent over a wide area network to a shared software-implemented service in a data center in the multi-tenant cloud computing platform, the data center having a plurality of bare metal machines for users; and,
responsive to the connection from the user agent and an identifier for the user, the software-implemented service providing the user with a console session into the user's currently assigned bare metal machine; and,
the software-implemented service connecting to the bare metal machine through intermediary hardware in the data center to a physical serial port of the user's currently assigned bare metal machine.
